(19) United States
(12) Patent Application Publication
(10) Pub. No.: US 2019/0293271 A1
(43) Pub. Date: Sep. 26, 2019

(54) LIGHTING DEVICE

(71) Applicant: SHENZHEN ROYOLE TECHNOLOGIES CO., LTD., Shenzhen (CN)

(72) Inventor: Wenjun LIU, Shenzhen (CN)

(21) Appl. No.: 16/435,908

(22) Filed: Jun. 10, 2019

Related U.S. Application Data
(63) Continuation of application No. PCT/CN2016/113644, filed on Dec. 30, 2016.

(51) Int. Cl. F21V 21/26; F21S 6/00; F21V 21/14

(52) U.S. Cl. CPC F21V 21/26; F21V 21/145; F21S 6/003

(57) ABSTRACT

A lighting device (100) is provided. The lighting device (100) includes a lamp body (10), a lamp rod (20), a lamp holder (30), and a rotation assembly (40). The lamp rod (20) is disposed on the lamp holder (30), and the lamp body (10) is rotatably connected to the lamp rod (20) via the rotation assembly (40). The lamp body (10) is configured to rotate relative to the lamp rod (20) to adjust an angle defined by the lamp body (10) and the lamp rod (20), such that the lighting device (100) is capable of folding, that is, the size of a space occupied by the lighting device (100) is adjustable. When the angle defined by the lamp body (10) and the lamp rod (20) is adjusted to reduce via the rotation assembly, that is, the lighting device (100) is folded, the space occupied by the lighting device (100) is reduced, thereby facilitating portability and transportation.

### CROSS-REFERENCE TO RELATED APPLICATION(S)

This application is a continuation of PCT application No. PCT/CN2016/113644, filed Dec. 30, 2016, the disclosure of which is hereby incorporated by reference in its entirety.

### TECHNICAL FIELD

The present disclosure relates to the field of lighting technologies, and particularly to a lighting device.

### BACKGROUND

Generally, a desk lamp is simply placed on a desk or a bedside for lighting and facilitating switching, and a common desk lamp is large in size and monotonous in structure, which is inconvenient for portability or transportation.

### SUMMARY

Embodiments of the present disclosure provide a lighting device to reduce the volume of the lighting device to facilitate portability or transportation.

A lighting device is provided. The lighting device includes a lamp body, a lamp rod, a lamp holder, and a rotation assembly. The lamp rod is disposed on the lamp holder, and the lamp body is rotatably connected to the lamp rod via the rotation assembly. The lamp body is configured to rotate relative to the lamp rod to adjust an angle defined by the lamp body and the lamp rod.

As one embodiment, the rotation assembly includes a baseplate and a fixing plate disposed on the baseplate, the fixing plate is fixedly connected with the lamp body, and the baseplate is rotatably connected to the lamp rod.

As one embodiment, the lighting device further includes a rotation member, and the baseplate is rotatably connected to the lamp rod via the rotation member.

As one embodiment, the rotation member includes a fixing portion and a rotation portion rotatably connected with the fixing portion, the fixing portion is connected with the lamp rod, and the rotation portion is connected to the baseplate.

As one embodiment, the baseplate is provided with a retainer to be fastened to and connected with the rotation portion.

As one embodiment, the lamp rod is provided with a fixing component, and the fixing component is fixedly connected with the fixing portion of the rotation member to fix the rotation member to the lamp rod.

As one embodiment, the lamp rod is in a cylindrical shape and has a top end and a bottom end disposed opposite to the top end, and the bottom end of the lamp rod is disposed on the lamp holder. The lamp rod has a groove, and the groove extends through the top end of the lamp rod. The baseplate is substantially received in the lamp rod, and the groove is configured to provide a space for rotation of the baseplate relative to the lamp rod.

As one embodiment, the lamp rod includes a first fastening tube and a second fastening tube. The first fastening tube has a fixing end configured as the fixing component, the fixing end has a first groove through an outer circumferential surface of the fixing end into an interior of the first fastening tube extending in a direction perpendicular to a longitudinal direction of the first fastening tube, and the first groove extends through an end surface of the fixing end in a direction parallel to the longitudinal direction of the first fastening tube. An end portion of the second fastening tube has a second groove extending through an outer circumferential surface of the end portion into an interior of the second fastening tube in a direction perpendicular to a longitudinal direction of the second fastening tube, and the second groove extends through an end surface of the end portion of the second fastening tube in a direction parallel to the longitudinal direction of the second fastening tube. The first groove and the second groove define the groove of the lamp rod after the first fastening tube is fixedly connected with the second fastening tube.

As one embodiment, the second fastening tube has a stopper plate extending from a side of the second groove, the stopper plate extends from an end of the second groove away from the first fastening tube into the interior of the second fastening tube, and the stopper plate is inclined toward the second groove to limit a rotational displacement of the baseplate.

As one embodiment, the fixing end of the first fastening tube has a first wall and a second wall, the first wall and the second wall are located on opposite sides of the first groove. The first wall has a fixing groove, and the baseplate is provided with the retainer. The fixing portion of the rotation member is fixedly connected with the fixing groove, and the rotation portion of the rotation member is fixedly connected with the retainer.

As one embodiment, the rotation member further includes a reinforcing portion fixedly connected to the rotation portion, the baseplate has an engagement recess, and a bottom portion of the engagement recess has a through hole. The second wall of the fixing end has a fixing hole, and the reinforcing portion of the rotation member extends through the fixing groove and the through hole of the engagement recess to rotatably connect with the fixing hole of the second wall of the fixing end.

As one embodiment, the lighting device further includes a sleeve, and the sleeve has a first opening corresponding to the groove of the lamp rod. The sleeve is sleeved around the first fastening tube and the second fastening tube to strengthen engagement between the first fastening tube and the second fastening tube.

As one embodiment, the fixing end of the first fastening tube further has a third groove opposite to the groove of the lamp rod, and the sleeve further has a second opening corresponding to the third groove.

As one embodiment, the lamp rod includes a support portion, a touch portion, and a fixing portion. The support portion is disposed on a top end of the touch portion, and the support portion includes the first fastening tube, the second fastening tube, and the sleeve. The touch portion is provided with a flexible touch panel configured to control power on and power off of the lamp body. A first end of the fixing portion of the lamp rod is disposed at a bottom end of the touch portion, and a second end of the fixing portion of the lamp rod opposite to the first end is disposed on the lamp holder.

As one embodiment, the lamp body includes a lamp portion and a connection tube, the lamp portion is disposed at a first end of the connection tube, and the connection tube is fixed to the fixing plate of the rotation assembly.

As one embodiment, a bottom portion of the connection tube has a fixing groove to be engaged with the fixing plate of the rotation assembly. The fixing groove has a first fastening component disposed therein, and a second fastening component is formed on the fixing plate. The first fastening component is aligned and interlocked with the second fastening component to mount the connection tube to the rotation assembly.

As one embodiment, the fixing groove has a through groove extending through a bottom portion of the fixing groove. The fixing plate has a groove extending through a bottom portion of the fixing plate. The baseplate has a hollow cavity. The through groove is in communication with the hollow cavity of the baseplate through the groove of the fixing plate to allow a cable of the lamp portion to extend into the lamp rod through the through groove, the groove of the fixing plate, and the hollow cavity.

As one embodiment, the lamp body further includes a night lamp disposed at a second end of the connection tube, and the second end of the connection tube is opposite to the first end of the connection tube.

As one embodiment, the lamp portion includes a bracket, a light source assembly mounted on the bracket, a lamp cover covering the light source assembly, and a switch assembly mounted on a front end of the bracket. A rear end of the bracket is fixed to the connection tube to fix the lamp portion to the connection tube.

As one embodiment, the bracket has a light source cavity for receiving and fixing the light source assembly. The rear end of the bracket has a first snap portion, the connection tube has a second snap portion, and the first snap portion is in snap-fit engagement with the second snap portion to fix the bracket to the connection tube by snap-fit engagement.

As one embodiment, the front end of the bracket has a switch cavity separated from the light source cavity, and the switch cavity is configured for receiving the switch assembly.

As one embodiment, the lamp portion further includes a casing tube disposed around an outer surface of the bracket. The switch assembly includes a circuit board, a button, and a collar. The circuit board is fixed in the switch cavity. The button is disposed above and abutted against the circuit board. The collar surrounds the button, and the collar is fixed to the casing tube to fix the button to the front end of the bracket.

As one embodiment, the button includes a pushing portion and a resilient arm disposed at a periphery of the pushing portion for providing a resilient force for the pushing portion to spring back.

The lighting device includes the lamp holder, the lamp rod disposed on the lamp holder, the rotation assembly, and the lamp body rotatably connected to the lamp rod via the rotation assembly. The lamp body is configured to rotate relative to the lamp rod to adjust the angle defined by the lamp body and the lamp rod, such that the lighting device is capable of folding, that is, the size of a space occupied by the lighting device is adjustable. When the angle defined by the lamp body and the lamp rod is adjusted to reduce via the rotation assembly (that is, the lighting device is folded), the space occupied by the lighting device is reduced, thereby facilitating portability and transportation.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description illustrate some embodiments of the present disclosure. Those of ordinary skill in the art may also obtain other drawings based on these accompanying drawings without creative efforts.

FIG. 1 is a schematic perspective view of a lighting device according to an embodiment of the present disclosure.

FIG. 2 is a cross-sectional view of the lighting device of FIG. 1 in a folded state.

FIG. 3 is a schematic view of a rotation assembly of the lighting device of FIG. 1.

FIG. 4 is a schematic view of a connection tube of the lighting device of FIG. 1.

FIG. 5 is a schematic view of a rotation member of the lighting device of FIG. 1.

FIG. 6 is a schematic view of the rotation assembly of the lighting device of FIG. 1 taken from another direction.

FIG. 7 is a partial schematic view of the lamp rod of the lighting device of FIG. 1.

FIG. 8 is a schematic view of a first fastening tube of the lamp rod of FIG. 7 taken from a first direction.

FIG. 9 is a schematic view of a first fastening tube of the lamp rod of FIG. 7 taken from a second direction.

FIG. 10 is a schematic view of a first fastening tube of the lamp rod of FIG. 7 taken from a third direction.

FIG. 11 is a schematic view of a second fastening tube of the lamp rod of FIG. 7 taken from a first direction.

FIG. 12 is a schematic view of a second fastening tube of the lamp rod of FIG. 7 taken from a second direction.

FIG. 13 is a schematic view of a sleeve of the lighting device of FIG. 1.

FIG. 14 is an exploded view of a lamp portion of FIG. 1.

FIG. 15 is a schematic view of a bracket of the lamp portion of FIG. 14 taken from a first direction.

FIG. 16 is a schematic view of the bracket of the lamp portion of FIG. 14 taken from a second direction.

FIG. 17 is an exploded view of a switch assembly of the lighting device of FIG. 1.

### DETAILED DESCRIPTION OF ILLUSTRATED EMBODIMENTS

Technical solutions in the embodiments of the present disclosure will be described clearly and completely hereinafter with reference to the accompanying drawings in the embodiments of the present disclosure.

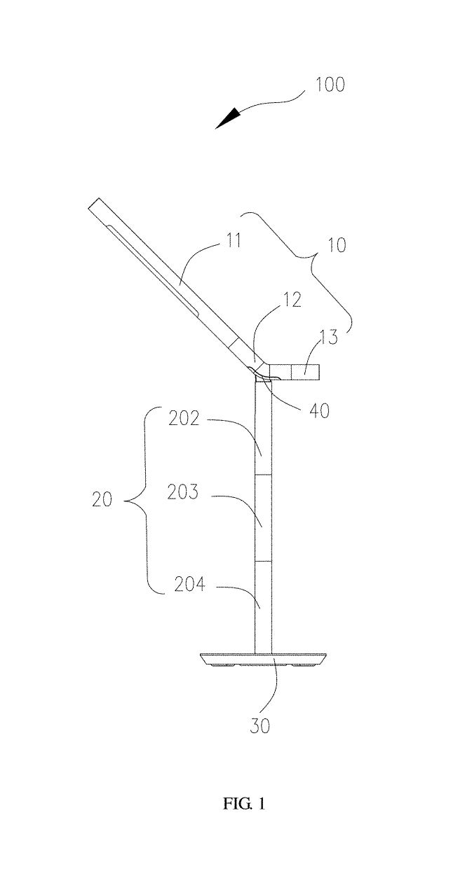

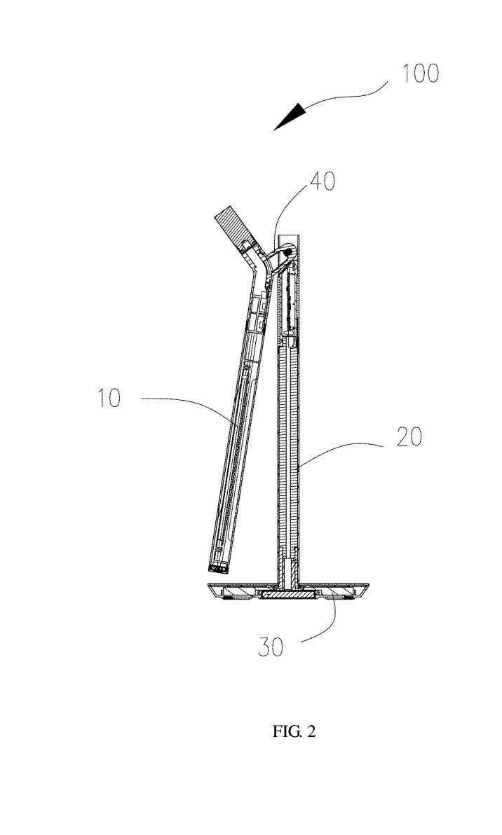

Referring to FIGS. 1 to 2, a lighting device 100 is provided. The lighting device 100 includes a lamp body 10, a lamp rod 20, a lamp holder 30, and a rotation assembly 40. The lamp rod 20 is disposed on the lamp holder 30. The lamp body 10 is rotatably connected to the lamp rod 20 via the rotation assembly 40. The lamp body 10 can rotate relative to the lamp rod 20 to adjust an angle defined by the lamp body 10 and the lamp rod 20.

In this embodiment, the lighting device 100 may be a desk lamp. The lamp body 10 is rotatable relative to the lamp rod 20 via the rotation assembly 40 to adjust the angle defined by the lamp body 10 and the lamp rod 20, such that the lighting device 100 is capable of folding, that is, the size of a space occupied by the lighting device 100 is adjustable. When the angle defined by the lamp body 10 and the lamp rod 20 is adjusted to reduce via the rotation assembly 40 (that is, the lighting device 100 is folded), the space occupied by the lighting device 100 is reduced, thereby facilitating portability and transportation. When the angle defined by the lamp body 10 and the lamp rod 20 is adjusted to increase via the rotation assembly 40 (that is, the lighting device 100 is expanded), the space occupied by the lighting device 100 is increased, thereby extending an illumination range.

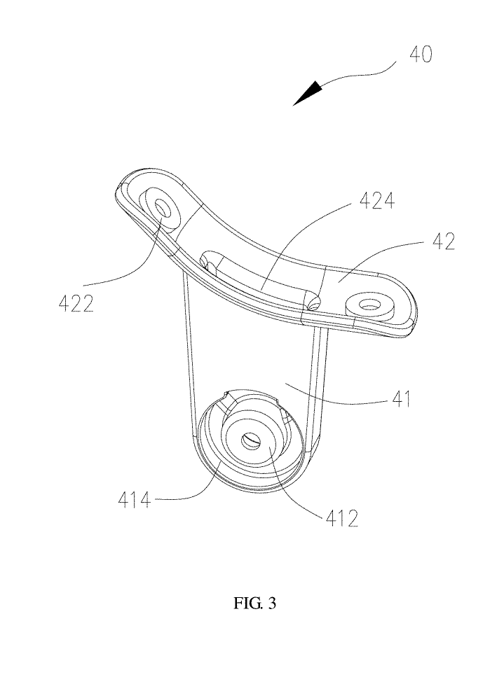

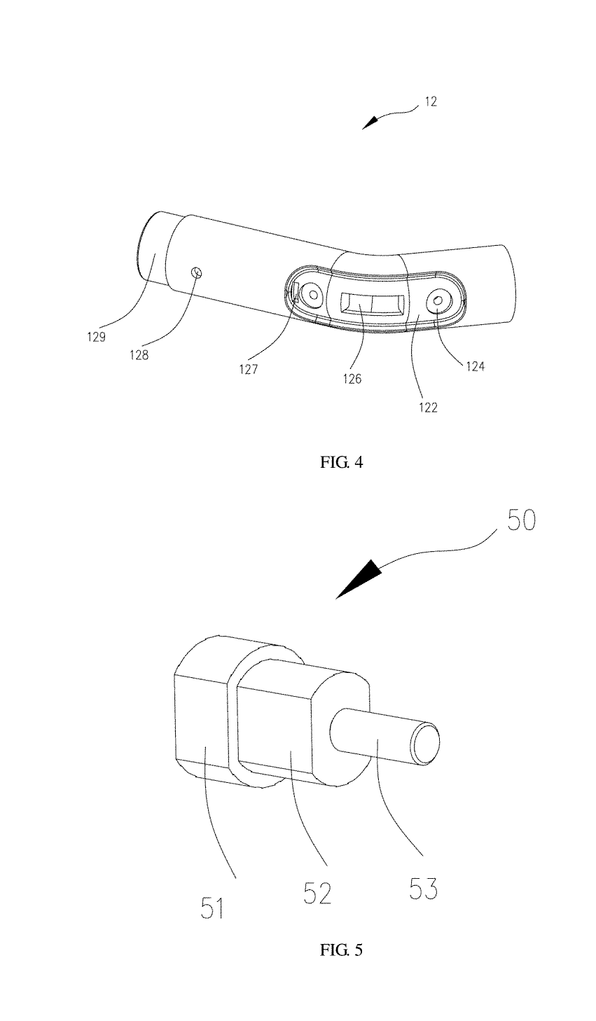

Referring to FIGS. 3 to 4, the rotation assembly 40 includes a baseplate 41 and a fixing plate 42 disposed on the baseplate 41. The fixing plate 42 is fixedly connected with the lamp body 10, and the baseplate 41 is rotatably connected to the lamp rod 20.

The lamp body 10 includes a lamp portion 11 and a connection tube 12. The lamp portion 11 is disposed at a first end of the connection tube 12 (that is, an end of the connection tube 12 away from the rotation assembly 40), and the connection tube 12 is fixed to the fixing plate 42 of the rotation assembly 40.

As one embodiment, the fixing plate 42 is mounted to a bottom portion of the connection tube 12. The bottom portion of the connection tube 12 has a fixing groove 122 to be engaged with the fixing plate 42 of the rotation assembly 40. The fixing groove 122 has a first fastening component 124 disposed therein, and a second fastening component 422 is formed on the fixing plate 42. The first fastening component 124 is aligned and interlocked with the second fastening component 422 to mount the connection tube 12 to the rotation assembly 40.

In this embodiment, both the first fastening component 124 and the second fastening component 422 are fixing blocks, and each of the fixing blocks has a fixing hole. The first fastening component 124 is fixedly connected with the second fastening component 422 by screws to mount and fix the connection tube 12 to the rotation assembly 40. In other embodiments, the fixing plate 42 can also be fixedly mounted and fixed to the bottom portion of the connection tube 12 by other means.

As one embodiment, the fixing groove 122 has a through groove 126 located therein and extending through a bottom portion of the fixing groove 122. The fixing plate 42 has a groove 424 extending through a bottom portion of the fixing plate 42. The baseplate 41 has a hollow cavity. The through groove 126 is in communication with the hollow cavity of the baseplate 41 through the groove 424 of the fixing plate 42 to allow a cable of the lamp portion 11 to extend into the lamp rod 20 through the through groove 126, the groove 424 of the fixing plate 42, and the hollow cavity.

It should be noted that, in the embodiment, the lamp holder 30 is provided with a battery therein for supplying power. The battery is coupled with the cable received in the lamp rod 20 and configured to provide an operating voltage for the lamp portion 11. In other embodiments, the lamp holder 30 may also be provided with a power supply line that is coupled with the cable received in the lamp rod 20, and the power supply line is configure to electrically connected to an external power outlet.

As one embodiment, an inner wall of the fixing groove 122 close to a first end of the fixing groove 122 (that is, close to the first end of the connection tube 12) has an engagement hole 127. The engagement hole 127 is in snap-fit engagement with the lamp portion 11. The connection tube 12 has a through hole 128 located close to the first end of the connection tube 12.

The first end of the connection tube 12 is stepped. A rear end of the lamp portion 11 is sleeved around a stepped portion 129 of the first end of the connection tube 12, such that the rear end of the lamp portion 11 is smoothly connected with the connection tube 12.

Referring to FIG. 1, the lamp body 10 further includes a night lamp 13 disposed at a second end of the connection tube 12, and the second end of the connection tube 12 is opposite to the first end of the connection tube 12. A cable of the night lamp 13 may also extend into the lamp rod 20 through the through groove 126, the groove 424, and the hollow cavity, and then connect the battery received in the lamp holder 30 through the lamp rod 20.

Referring to FIG. 5, the lighting device 100 further includes a rotation member 50. The baseplate 41 is rotatably connected to the lamp rod 20 via the rotation member 50.

As one embodiment, the rotation member 50 includes a fixing portion 51 and a rotation portion 52 rotatably connected with the fixing portion 51. For example, the rotation portion 52 is provided with a rotation rod, the fixing portion 51 had a hole fitted with the rotation rod, and the rotation rod is received in and rotatable with respect to the hole of the fixing portion 51. It should be noted that, the rotation portion 52 can be rotatably connected with the fixing portion 51 by other means. The fixing portion 51 is connected with the lamp rod 20, and the rotation portion 52 is connected to the baseplate 41.

As one embodiment, the rotation member 50 further includes a reinforcing portion 53 fixedly connected to the rotation portion 52.

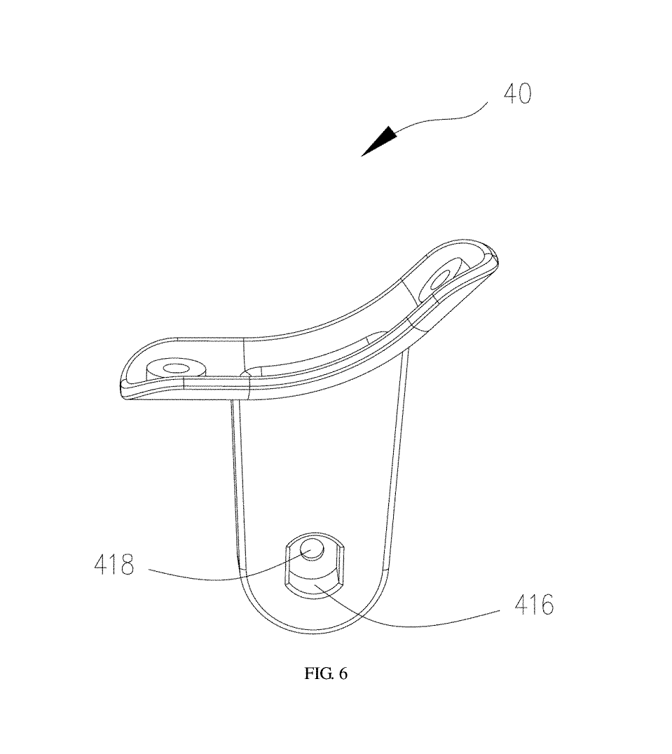

Referring to FIG. 3 and FIG. 6, a bottom portion of the baseplate 41 (that is, a portion of the baseplate 41 away from the fixing plate 42) is provided with a retainer 412. The retainer 412 is fixedly connected with the rotation portion 52.

In this embodiment, the retainer 412 can be a boss. The bottom portion of the baseplate 41 has a ring recess 414. The ring recess 414 is in communication with the hollow cavity of the baseplate 41. The retainer 412 is formed within the ring recess 414, and the retainer 412 of the baseplate 41 has an engagement recess 416 extending from a back surface of the retainer 412. The engagement recess 416 is engaged with the rotation portion 52. A bottom wall of the engagement recess 416 has a through hole 418 corresponding to the reinforcing portion 53.

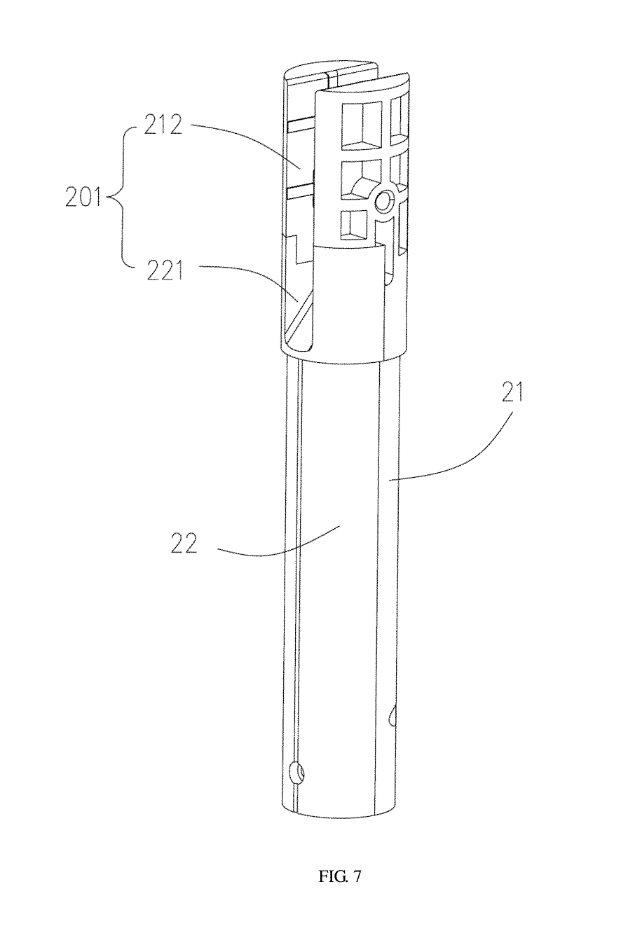

Referring to FIG. 7, the lamp rod 20 is provided with a fixing component, and the fixing component is fixedly connected with the fixing portion 51 of the rotation member 50 to fix the rotation member 50 to the lamp rod 20.

As one embodiment, the lamp rod 20 is in a cylindrical shape and has a top end and a bottom end disposed opposite to the top end, and the bottom end of the lamp rod 20 is disposed on the lamp holder 30. The lamp rod 20 has a groove 201, and the groove 201 extends through the top end of the lamp rod 20 in a direction parallel to a longitudinal direction of the lamp rod 20. The baseplate 41 is substantially received in the lamp rod 20 (that is, whole or most of the baseplate 41 is received in the lamp rod 20), and the groove 201 is configured to provide a space for rotation of the baseplate 41 relative to the lamp rod 20.

It should be noted that, the groove 201 is configured to provide the space for the rotation of the baseplate 41 relative to the lamp rod 20. That is, when the baseplate 41 is rotating relative to the lamp rod 20, the baseplate 41 is progressively received in the groove 201, thereby reducing the angle defined by the lamp body 10 and the lamp rod 20.

As one embodiment, the lamp rod 20 includes a first fastening tube 21 and a second fastening tube 22. The first fastening tube 21 has a fixing end 211 configured as the fixing component. The fixing end 211 has a first groove 212 extending through an outer circumferential surface of the fixing end 211 into an interior of the first fastening tube 21 in a direction perpendicular to a longitudinal direction of the first fastening tube 21, and the first groove 212 extends through an end surface of the fixing end 211 in a direction parallel to the longitudinal direction of the first fastening tube 21. An end portion of the second fastening tube 22 has a second groove 221 extending through an outer circumferential surface of the end portion into an interior of the second fastening tube 22 in a direction perpendicular to a longitudinal direction of the second fastening tube 22, and the second groove 221 extends through an end surface of the end portion of the second fastening tube 22 in a direction parallel to the longitudinal direction of the second fastening tube 22. The first groove 212 and the second groove 221 define the groove 201 of the lamp rod 20 after the first fastening tube 21 is fixedly connected with the second fastening tube 22.

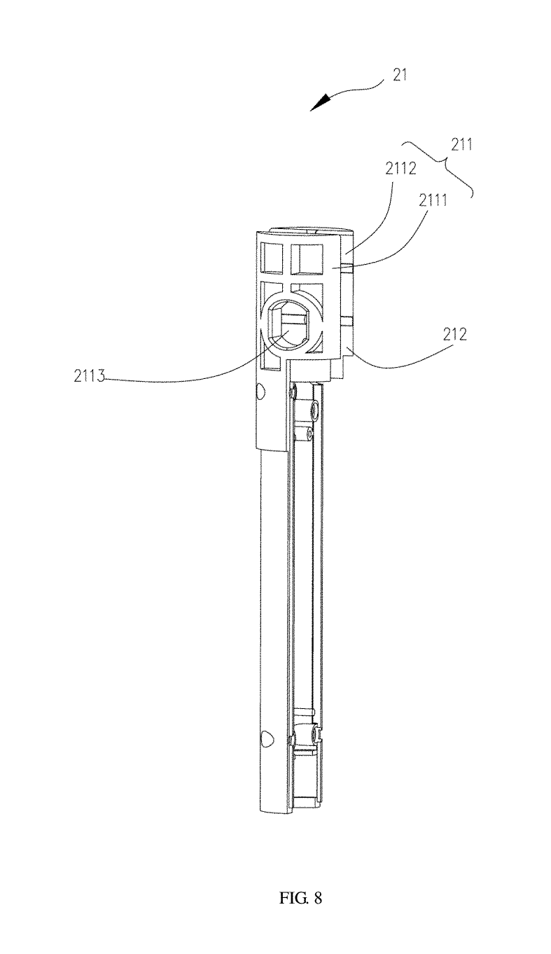

Referring FIG. 8, the fixing end 211 of the first fastening tube 21 has a first wall 2111 and a second wall 2112, the first wall 2111 and the second wall 2112 are located on opposite sides of the first groove 212. The first wall 2111 has a fixing groove 2113, and the fixing portion 51 of the rotation member 50 is fixedly connected with the fixing groove 2113. The back surface of the retainer 412 is close to the first fastening tube 211.

In this embodiment, the fixing portion 51 of the rotation member 50 is received and fixed in the fixing groove 2113. The cross-sectional area of the fixing groove 2113 is larger than that of an engagement recess 416 of the baseplate 41. The fixing portion 51 of the rotation member 50 matches the fixing groove 2113, and the rotation portion 52 of the rotation member 50 matches the engagement recess 416.

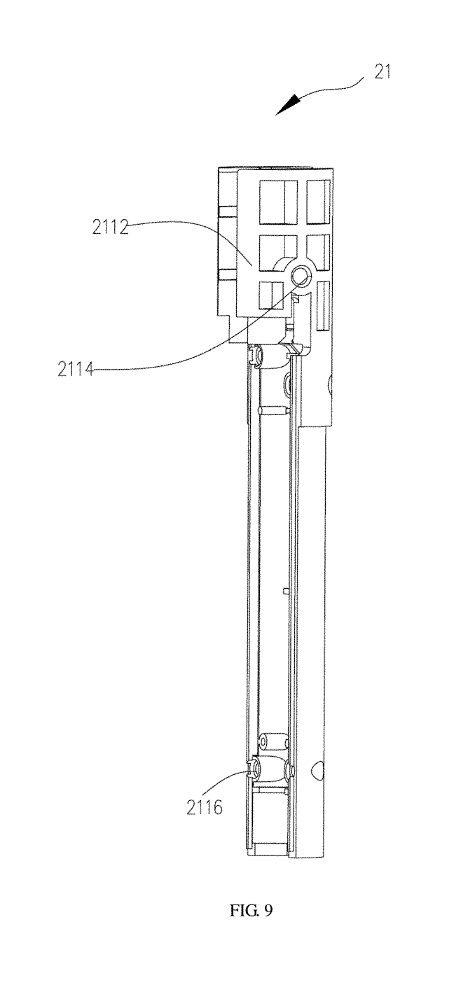

Referring to FIG. 9, the second wall 2112 of the fixing end 211 has a fixing hole 2114 corresponding to the reinforcing portion 53 of the rotation portion 52. The reinforcing portion 53 extends through the fixing groove 2113 and the through hole 418 of the engagement recess 416 to rotatably connect with the fixing hole 2114 of the second wall 2112.

Further, the first fastening tube 21 has a through hole 2116.

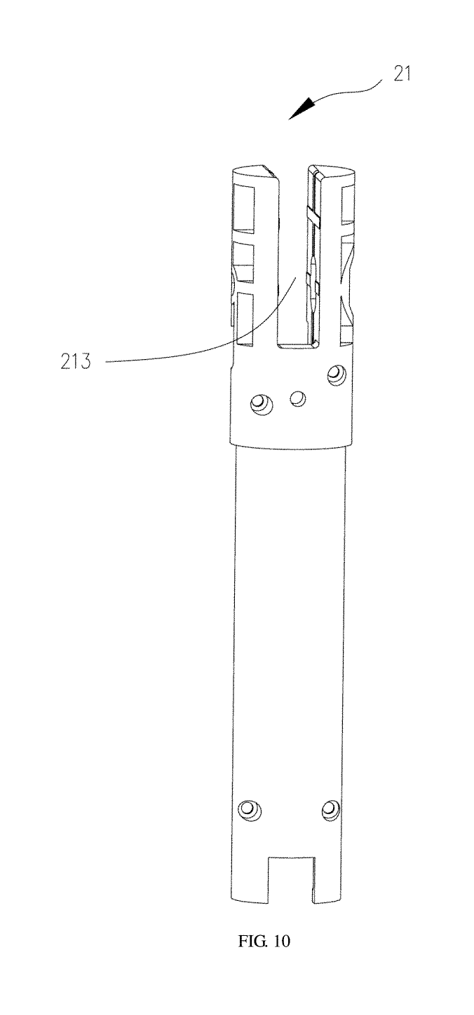

Referring to FIG. 10, the fixing end 211 of the first fastening tube 21 further has a third groove 213 opposite to the first groove 212. The third groove 213 extends through the outer circumferential surface of the fixing end 211 into the interior of the first fastening tube 21 in the direction perpendicular to the longitudinal direction of the first fastening tube 21, and the third groove 213 extends through the end surface of the fixing end 211 in the direction parallel to the longitudinal direction of the first fastening tube 21. The third groove 213 is in parallel to and in communication with the first groove 212.

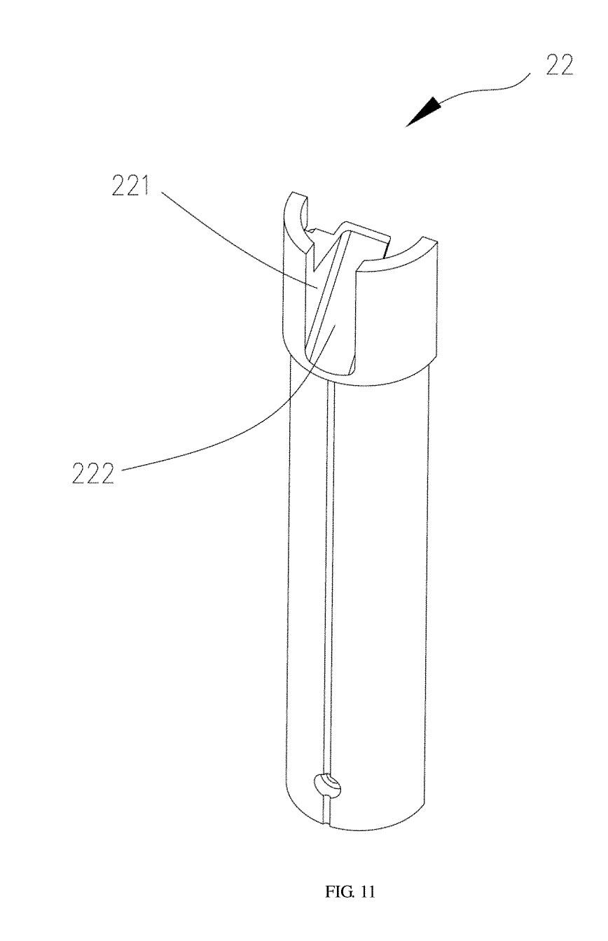

Referring to FIG. 11, the second fastening tube 22 has a stopper plate 222 extending from a side of the second groove 221. The stopper plate 222 extends from an end of the second groove 221 away from the first fastening tube 21 into an interior of the second fastening tube 22. The stopper plate 222 is inclined toward the second groove 221 to limit a rotational displacement of the baseplate 41.

Referring to FIG. 12, the second fastening tube 22 has a screw hole 224 corresponding to the through hole 2116 of the first fastening tube 21. A screw extends through the through hole 2116 to engage with the screw hole 224, such that the first fastening tube 21 is fixedly connected with the second fastening tube 22.

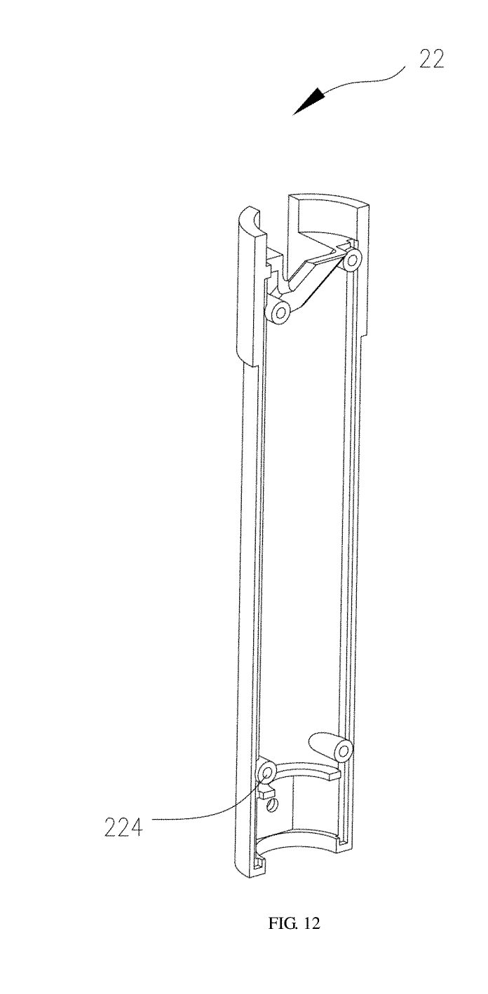

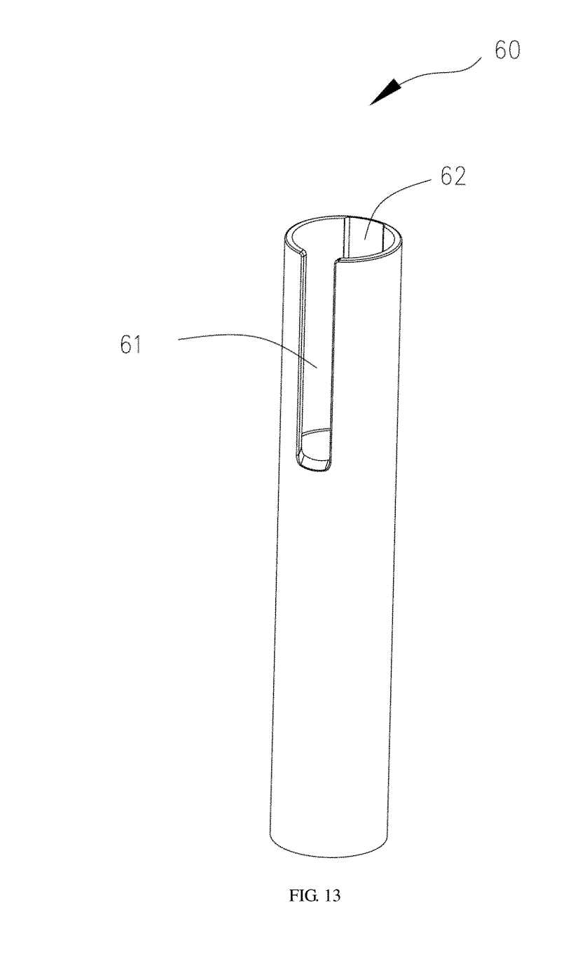

Referring to FIG. 13, the lighting device 100 further includes a sleeve 60, the sleeve 60 has a first opening 61 corresponding to the groove 201 of the lamp rod 20. The sleeve 60 is sleeved around the first fastening tube 21 and the second fastening tube 22 to strengthen engagement between the first fastening tube 21 and the second fastening tube 22.

As one embodiment, the sleeve 60 further has a second opening 62 corresponding to the third groove 213.

Referring to FIG. 1, the lamp rod 20 includes a support portion 202, a touch portion 203, and a fixing portion 204. The support portion 202 is disposed on a top end of the touch portion 203, and the support portion 202 includes the first fastening tube 21, the second fastening tube 22, and the sleeve 50. The touch portion 203 is provided with a flexible touch panel (not shown) configured to control power on and power off of the lamp body 10. A first end of the fixing portion 204 of the lamp rod 20 is disposed at a bottom end of the touch portion 203, and a second end of the fixing portion 2014 of the lamp rod 20 opposite to the first end of the fixing portion 204 of the lamp rod 20 is disposed on the lamp holder 30.

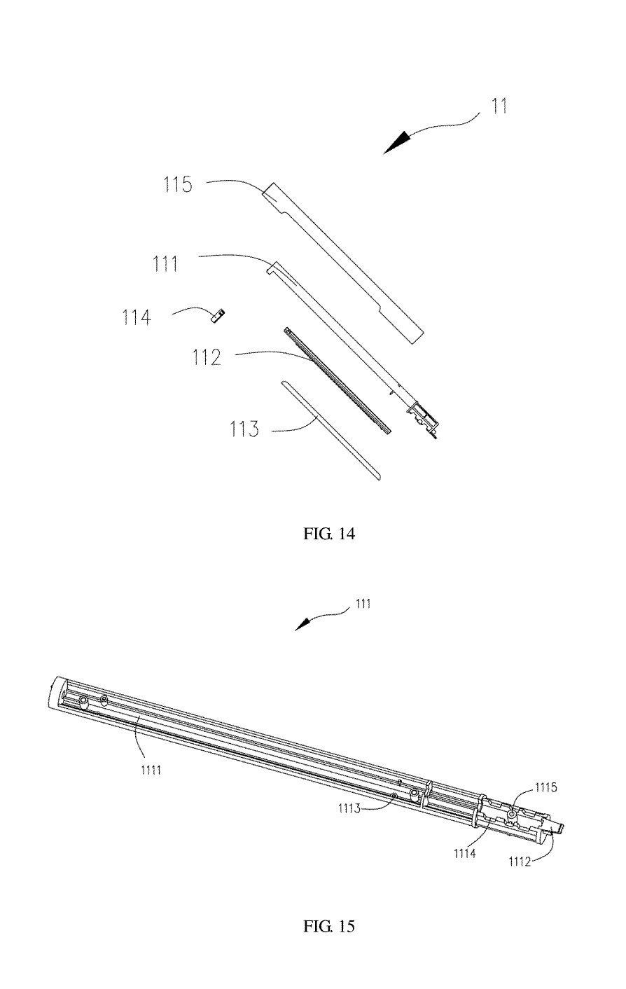

Referring FIG. 14, the lamp portion 11 includes a bracket 111, a light source assembly 112 mounted on the bracket 111, a lamp cover 113 covering the light source assembly 112, and a switch assembly 114 mounted on a front end of the bracket 111. A rear end of the bracket 111 is fixed to the connection tube 12 to fix the lamp portion 11 to the connection tube 12.

As one embodiment, the lamp portion 11 further includes a casing tube 115 disposed around an outer surface of the bracket 111. In this embodiment, the casing tube 115 is integrally formed of a metal material.

Referring to FIG. 15, the bracket 111 has a light source cavity 1111 for receiving and fixing the light source assembly 112. The rear end of the bracket 111 has a first snap portion 1112, the connection tube has a second snap portion, and the first snap portion 1112 is in snap-fit engagement with the second snap portion to fix the bracket 111 to the connection tube 12 by snap-fit engagement. As one embodiment, the second snap portion is the engagement hole 127 formed in the connection tube 12.

In this embodiment, the first snap portion 1112 is a hook. The light source assembly 112 is received in the light source cavity 1111 and is fixed in the light source cavity 1111 by a locking and fixing manner. Specifically, the light source cavity 1111 has fixing posts 1113 for fixing with the light source assembly 112. The bracket 111 has wire slots 1114 close to the rear end of the bracket 111 for wires of the light source assembly 1111 to pass through. The bracket 111 is provided with a stud 1115 close to the rear end of the bracket 111, and the stud 1115 corresponds to the through hole 128 of the connection tube 12. A screw extends through the through hole 128 to engage with the stud 1115, such that the bracket 111 is fixed to the connection tube 12.

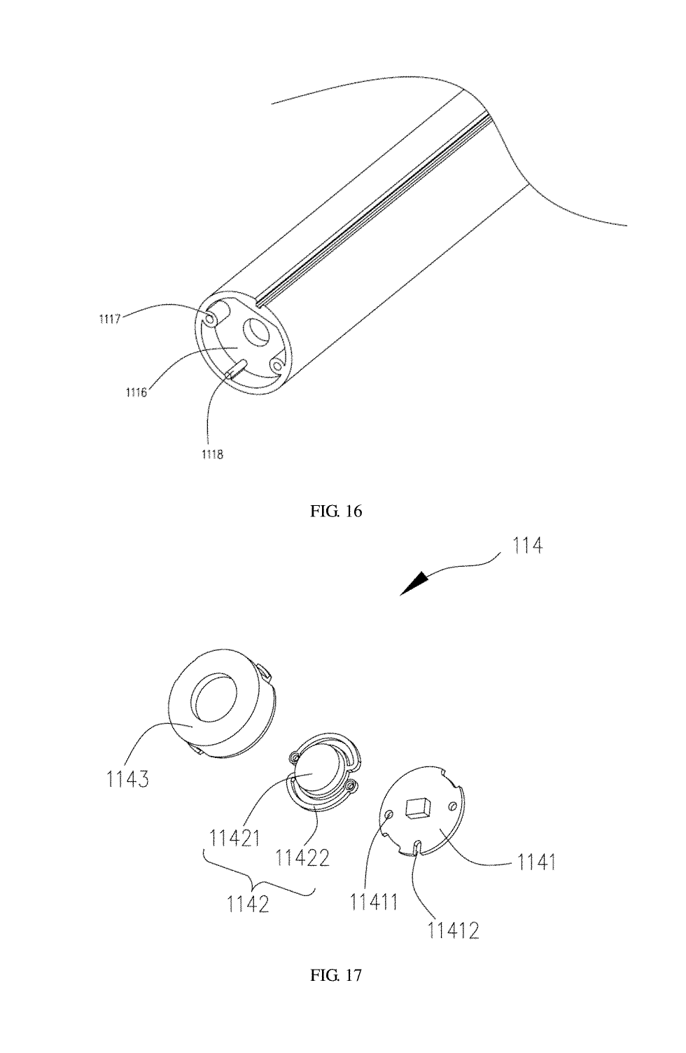

Referring FIG. 16, the front end of the bracket 111 has a switch cavity 1116 separated from the light source cavity 1111, the switch cavity 1116 is used for receiving the switch assembly 114.

As one embodiment, a fixing post 1117 and a positioning post 1118 are disposed in the switch cavity 1116. The fixing post 1117 is used to fix the switch assembly 114. The positioning post 1118 is used to position the switch assembly 114.

Referring to FIG. 17, the switch assembly 114 includes a circuit board 1141, a button 1142, and a collar 1143. The circuit board 1141 is fixed in the switch cavity 1116. The button 1142 is disposed above and abutted against the circuit board 1141. The collar 1143 surrounds the button 1142 and is fixed to the casing tube 115, such that the button 1142 is secured to the front end of the bracket 111.

As one embodiment, the button 1142 includes a pushing portion 11421 and a resilient arm 11422 disposed at a periphery of the pushing portion for providing a resilient force for the pushing portion 11421 to spring back. The resilient force enables the button 1142 automatically rebound after the button 1142 is pressed.

It should be noted that the circuit board 1141 has a fixing hole 11411 corresponding to the fixing post 1117 in the switch cavity 1116 and a positioning hole 11412 corresponding to the positioning post 1118. When the fixing post 1117 is inserted into the fixing hole 11411 and the positioning post 1118 is inserted into the positioning hole 11412, the circuit board 1141 is positioned and fixed in the switch cavity 1116.

The present disclosure has been described above with reference to the preferred embodiments. It should be noted that various modifications and changes may be made by those skilled in the art without departing from the spirit and principle of the present disclosure, and such modifications and changes are also considered to be within the scope of present disclosure.

What is claimed is:

1. A lighting device, comprising:
a lamp body;
a lamp rod;
a lamp holder; and
a rotation assembly, wherein the lamp rod is disposed on the lamp holder, and wherein the lamp body is rotatably connected to the lamp rod via the rotation assembly; and
wherein the lamp body is configured to rotate relative to the lamp rod to adjust an angle defined by the lamp body and the lamp rod.

2. The lighting device of claim 1, wherein the rotation assembly comprises a baseplate and a fixing plate disposed on the baseplate, wherein the fixing plate is fixedly connected with the lamp body, and wherein the baseplate is rotatably connected to the lamp rod.

3. The lighting device of claim 2, further comprising a rotation member, wherein the baseplate is rotatably connected to the lamp rod via the rotation member.

4. The lighting device of claim 3, wherein the rotation member comprises a fixing portion and a rotation portion rotatably connected with the fixing portion, wherein the fixing portion is connected with the lamp rod, and wherein the rotation portion is connected to the baseplate.

5. The lighting device of claim 4, wherein the baseplate is provided with a retainer to be fastened to and connected with the rotation portion.

6. The lighting device of claim 5, wherein the lamp rod is provided with a fixing component, and wherein the fixing component is fixedly connected with the fixing portion of the rotation member to fix the rotation member to the lamp rod.

7. The lighting device of claim 6, wherein:
the lamp rod is in a cylindrical shape and has a top end and a bottom end disposed opposite to the top end, wherein the bottom end of the lamp rod is disposed on the lamp holder;
the lamp rod has a groove extending through the top end of the lamp rod; and
the baseplate is substantially received in the lamp rod, wherein the groove is configured to provide a space for rotation of the baseplate relative to the lamp rod.

8. The lighting device of claim 7, wherein:
the lamp rod comprises a first fastening tube and a second fastening tube;
the first fastening tube has a fixing end configured as the fixing component, the fixing end having a first groove extending through an outer circumferential surface of the fixing end into an interior of the first fastening tube in a direction perpendicular to a longitudinal direction of the first fastening tube, and the first groove extending through an end surface of the fixing end in a direction parallel to the longitudinal direction of the first fastening tube;
an end portion of the second fastening tube has a second groove extending through an outer circumferential surface of the end portion into an interior of the second fastening tube in a direction perpendicular to a longitudinal direction of the second fastening tube, the second groove extending through an end surface of the end portion of the second fastening tube in a direction parallel to the longitudinal direction of the second fastening tube; and
the first groove and the second groove define the groove of the lamp rod after the first fastening tube is fixedly connected with the second fastening tube.

9. The lighting device of claim 8, wherein:
the second fastening tube has a stopper plate extending from a side of the second groove;
the stopper plate extends from an end of the second groove away from the first fastening tube into the interior of the second fastening tube; and
the stopper plate is inclined toward the second groove to limit a rotational displacement of the baseplate.

10. The lighting device of claim 9, wherein:
the fixing end of the first fastening tube has a first wall and a second wall, wherein the first wall and the second wall are located on opposite sides of the first groove;
the first wall has a fixing groove;
the baseplate is provided with the retainer;
the fixing portion of the rotation member is fixedly connected with the fixing groove; and
the rotation portion of the rotation member is fixedly connected with the retainer.

11. The lighting device of claim 10, wherein:
the rotation member further comprises a reinforcing portion fixedly connected to the rotation portion;
the baseplate has an engagement recess, and a bottom portion of the engagement recess has a through hole;
the second wall of the fixing end has a fixing hole; and
the reinforcing portion of the rotation member extends through the fixing groove and the through hole of the engagement recess to rotatably connect with the fixing hole of the second wall of the fixing end.

12. The lighting device of claim 9, further comprising a sleeve, wherein:
the sleeve has a first opening corresponding to the groove of the lamp rod; and
the sleeve is sleeved around the first fastening tube and the second fastening tube to strengthen engagement between the first fastening tube and the second fastening tube.

13. The lighting device of claim 12, wherein:
the fixing end of the first fastening tube further has a third groove opposite to the groove of the lamp rod; and
the sleeve further has a second opening corresponding to the third groove.

14. The lighting device of claim 12, wherein:
the lamp rod comprises a support portion, a touch portion, and a fixing portion;
the support portion is disposed on a top end of the touch portion, and comprises the first fastening tube, the second fastening tube, and the sleeve;
the touch portion is provided with a flexible touch panel configured to control power on and power off of the lamp body; and
a first end of the fixing portion of the lamp rod is disposed at a bottom end of the touch portion, and a second end of the fixing portion of the lamp rod opposite to the first end is disposed on the lamp holder.

15. The lighting device of claim 2, wherein:
the lamp body comprises a lamp portion and a connection tube, wherein the lamp portion is disposed at a first end of the connection tube, and wherein the connection tube is fixed to the fixing plate of the rotation assembly;
a bottom portion of the connection tube has a fixing groove to be engaged with the fixing plate of the rotation assembly;
the fixing groove has a first fastening component disposed therein;
a second fastening component is formed on the fixing plate; and
the first fastening component is aligned and interlocked with the second fastening component to mount the connection tube to the rotation assembly.

16. The lighting device of claim 15, wherein:
the fixing groove has a through groove located therein and extending through a bottom portion of the fixing groove;
the fixing plate has a groove extending through a bottom portion of the fixing plate;
the baseplate has a hollow cavity; and
the through groove is in communication with the hollow cavity of the baseplate through the groove of the fixing plate to allow a cable of the lamp portion to extend into the lamp rod through the through groove, the groove of the fixing plate, and the hollow cavity.

17. The lighting device of claim 15, wherein:
the lamp body further comprises a night lamp disposed at a second end of the connection tube, and wherein the second end of the connection tube is opposite to the first end of the connection tube;
the lamp portion comprises a bracket, wherein a light source assembly is mounted on the bracket, wherein a lamp cover covers the light source assembly, and wherein a switch assembly is mounted on a front end of the bracket; and
a rear end of the bracket is fixed to the connection tube to fix the lamp portion to the connection tube.

18. The lighting device of claim 17, wherein:
the bracket has a light source cavity for receiving and fixing the light source assembly;
the rear end of the bracket has a first snap portion;
the connection tube has a second snap portion; and
the first snap portion is in snap-fit engagement with the second snap portion to fix the bracket to the connection tube by snap-fit engagement.

19. The lighting device of claim 18, wherein the front end of the bracket has a switch cavity separated from the light source cavity, and wherein the switch cavity is configured for receiving the switch assembly.

20. The lighting device of claim 19, wherein:
the lamp portion further comprises a casing tube disposed around an outer surface of the bracket;
the switch assembly comprises a circuit board, a button, and a collar;
the circuit board is fixed in the switch cavity;
the button is disposed above and abutted against the circuit board; and
the collar surrounds the button and is fixed to the casing tube to fix the button to the front end of the bracket.

21. The lighting device of claim 20, wherein the button comprises a pushing portion and a resilient arm disposed at a periphery of the pushing portion for providing a resilient force for the pushing portion to spring back.
